(19) United States
(12) Patent Application Publication
(10) Pub. No.: US 2025/0299671 A1
(43) Pub. Date: Sep. 25, 2025

(54) VIRTUAL AGENT VOICEOVER CACHING FOR ADAPTIVE SPEECH

(71) Applicant: TRIPP, Inc., Los Angeles, CA (US)

(72) Inventors: David Schwarz, Morrisville, NC (US); Nanea Reeves, Sherman Oaks, CA (US); Justin Patrick Taber, Shelton, WA (US); Colin Davies, Walnut Creek, CA (US); Parisa Rostamabadi, Kelowna (CA)

(21) Appl. No.: 18/611,142

(22) Filed: Mar. 20, 2024

(51) Int. Cl. G10L 15/183; G10L 15/18; G10L 15/22; G10L 15/30; G10L 25/63

(52) U.S. Cl. CPC G10L 15/183; G10L 15/1822; G10L 15/22; G10L 15/30; G10L 25/63

(57) ABSTRACT

A system adaptively generates a virtual experience inclusive of a virtual agent. The system receives speech text from a constrained machine-learned language model configured to provide adaptive speech for the agent. The system parses the speech text into a plurality of speech units, wherein a speech unit is an atomic unit representative of natural breaks in human speech. The system applies a hashing function to each speech unit to determine a corresponding hash. The system, for each hash, queries a cache database to identify whether the cache database includes a cached hash that matches the queried hash. Responsive to identifying a matching hash to a first queried hash, the system retrieves a first audio byte stored with the matching hash. The system generates a voiceover track for the virtual agent with the first audio byte for presentation to a user.

### BACKGROUND

### Technical Field

This disclosure relates generally to a media content system, and more specifically, to a media device that intelligently provides generative voiceover tracks for adaptive speech.

### Description of the Related Art

Conventional voiceover media content typically rely on voice actors and actresses to recite scripted text, which is recorded and used to voiceover virtual characters or agents. In a gaming context, a virtual reality application context, or a conversational platform, for example, each line of speech is recorded and then used to voiceover the virtual character or agent. With the advent of machine-learned language models and other generative algorithms, media content can now be adaptively generated. This may include generative speech for a virtual character or agent, leveraging a machine-learned language model. However, such models are text-based-they input text prompts and output text responses. To bridge the gap into crafting voiceover content, such text responses can be separately fed into a vocal synthesizer to generate the voiceover audio signal for the virtual character or agent.

However, various technical challenges arise when integrating the two components. For one, vocal synthesis is a time-intensive process. In generating voiceover audio from a language model text response, there is delay in waiting for the full audio signal to be transcribed from the text response. For two, conventional machine-learned language models typically output textual responses in one of two manners: for one, a stream of text, or, for two, a block of text. In the first manner of output, feeding individual words into the vocal synthesizer can aid in lag reduction, but at the cost of creating a disjointed voiceover track, where intonation between words in a sentence can be inconsistent. In the second manner of output, waiting for the language model to output the entire block of text and then generating audio for the entire block of text can create a coherent voice track, but at the cost of high latency.

### SUMMARY

A media system generates voiceover tracks for adaptive speech by a virtual agent. The media system may be implemented in a gaming context, a virtual reality application context, or a conversational platform. In the gaming context, the virtual agent may be a character (e.g., a non-playable character) that converses with the player. In the virtual reality application context, the media system may present a virtual reality experience (e.g., for meditation, for gaming, for other entertainment) including a virtual agent. In the conversational platform context, the conversational platform may include an interface (e.g., an audio call, or a video call) for communicating with a virtual agent. In this context, the conversational agent may be a digital assistant, performing actions, providing recommendation, or otherwise responding to voice prompts by a user. Alternatively, the conversational agent may be leveraged in a therapy application, as a therapist engaging with the user about the user's feelings, emotions, fears, coping skills, trauma, etc. In these various contexts, the media system can generate adaptive speech and generate novel voiceover tracks for the adaptive speech.

To generate the adaptive speech, the media system leverages a machine-learned language model (e.g., a large language model (LLM)) to generate the adaptive speech. In leveraging the machine-learned language model, the virtual reality system may craft a prompt to input into the machine-learned language model which outputs a text response including the adaptive speech for the virtual agent. In embodiments where the user may converse with the virtual agent, the prompt may include the conversation history, to inform more insightful adaptive speech. The prompt may further include added context of the virtual agent's speech.

The media system generates the voiceover track by parsing the adaptive speech into speech units and leveraging a voice synthesizer and cache database. With the model's response, the media system parses the speech text into speech units, which are atomic units of the speech text representative of natural breaks in human speech. For example, the speech unit can be phrases, sentence clauses, full sentences, or some combination thereof. The media system hashes each speech unit and queries a cache database with each hash. If the cache database identifies a match, i.e., indicating the hash is cached in the cache database, the media system retrieves an audio byte stored with the cached hash. If the cache database identifies no match, the media system generates an audio byte for the non-cached hash (i.e., a novel hash). The media system may further cache the novel hash with the generated audio byte in the cache database. The media system generates the voiceover track for the adaptive speech by combining the audio bytes for the speech units of the adaptive speech. The media system may then present the voiceover track in conjunction with the virtual agent.

### BRIEF DESCRIPTIONS OF THE DRAWINGS

The disclosed embodiments have other advantages and features which will be more readily apparent from the following detailed description of the invention and the appended claims, when taken in conjunction with the accompanying drawings, in which:

FIG. 1 illustrates a media system, according to one or more embodiments.

FIG. 2 is a block diagram of a media processing device, according to one or more embodiments.

FIG. 3 is a block diagram of a media server, according to one or more embodiments.

FIG. 4 is an illustrative flowchart of virtual agent voiceover caching of adaptive speech, according to one or more embodiments.

FIG. 5 is a method flowchart of virtual agent voiceover caching of adaptive speech, according to one or more embodiments.

FIG. 6 illustrates an example virtual reality experience including a virtual agent, according to one or more example implementations.

### DETAILED DESCRIPTION

### Overview of Virtual Reality Meditative Experience

In one or more embodiments, a virtual reality application adaptively generates a virtual reality meditative experience, e.g., for improving a user's mood. The virtual reality meditative experience may include virtual reality content, augmented reality content, mixed reality content, or some combination thereof. In general, the virtual reality meditative experience includes some amount of virtual content that is presented to the user. Example virtual content may include virtually-generated visual content, audio content, haptic content, or some combination thereof. The virtual reality experience may be presented to a user on a headset device. The headset device may include a display device for presenting virtually-generated visual content and/or and audio device for presenting audio content. The headset device may also include one or more input devices configured to receive inputs from the user or from a surrounding environment.

The virtual reality application presents a personalized virtual reality meditative experience that includes a virtual agent for guided meditation. The virtual agent may be an interactive character in the virtual reality meditative experience. The virtual agent may include a visual appearance and a voiceover track. The visual appearance may be defined by a set of characteristics, and the voiceover track may be defined by a set of characteristics. During presentation of the virtual reality meditative experience, the virtual reality application may modify the virtual agent to induce a mood shift in the user. The virtual reality application may receive a set of signals indicating a state of the user, e.g., a physical state, a mental state, an emotional state, a medicated state, a spiritual state, or some combination thereof. The virtual reality application may determine the user's mood based on the received set of signals. If the user's mood does not match a target mood to be achieved, the virtual reality application may modify the virtual agent and/or the virtual reality experience to shift the user's mood towards the target mood. In some embodiments, the virtual reality application may maintain a user profile that tracks responses of the user to the various modifications to the virtual agent and/or the virtual reality experience.

In one or more embodiments, the virtual reality application generates adaptive content. The adaptive content may include adaptive speech by the virtual agent, presented with a voiceover track. In such embodiments, the virtual reality application may generate the adaptive speech as the user converses with the virtual agent. In other embodiments, the virtual reality application may generate the adaptive speech based on a user's mood or other sensed environmental factors. The virtual reality application leverages a machine-learned language model (e.g., a large language model (LLM)) to generate the adaptive speech. In leveraging the machine-learned language model, the virtual reality application may craft a prompt to input into the machine-learned language model which outputs a text response including the adaptive speech for the virtual agent. In embodiments where the user may converse with the virtual agent, the prompt may include the conversation history, to inform more insightful adaptive speech. With the model's response, the virtual reality application parses the speech text into speech units, which are atomic units of the speech text representative of natural breaks in human speech. For example, the speech unit can be phrases, sentence clauses, full sentences, or some combination thereof. The virtual reality application hashes each speech unit and queries a cache database with each hash. If the cache database identifies a match, i.e., indicating the hash is cached in the cache database, the virtual reality application retrieves an audio byte stored with the cached hash. If the cache database identifies no match, the virtual reality application generates an audio byte for the non-cached hash (i.e., a novel hash). The virtual reality application may further cache the novel hash with the generated audio byte in the cache database. The virtual reality application generates the voiceover track for the adaptive speech by combining the audio bytes for the speech units of the adaptive speech. The virtual reality application then presents the voiceover track in the virtual reality meditative experience.

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Media System

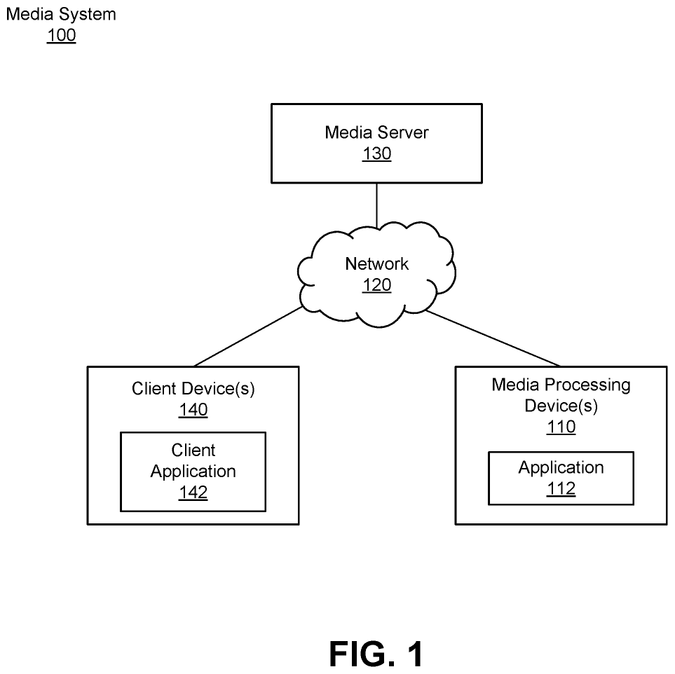

FIG. 1 is a block diagram of a media system 100, according to one or more embodiments. The media system 100 includes a network 120, a media server 130, one or more media processing devices 110 for executing an application 112, and one or more client devices 140 executing a client application 142. In alternative configurations, different and/or additional components may be included in the media content system 100. For example, in a gaming context, the media system 100 may include the media processing device 110 connected to the media server 130. As another example, in a conversational platform context, the media system 100 may include the client device 140 connected to the media server 130. In other embodiments, the functionality of the devices may be combined under a single device, or disparately distributed between the devices.

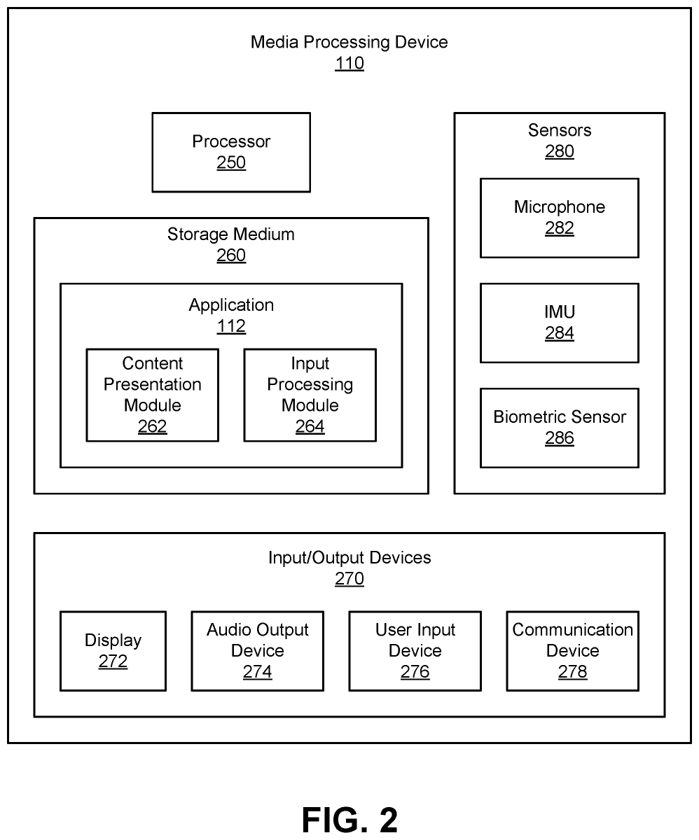

The media processing device 110 comprises a computer device for processing and presenting media content such as audio, images, video, or a combination thereof. The application 112 presents the media content, whereas other input devices receive user input. In an embodiment, the media processing device 110 is a head-mounted VR device. The media processing device 110 may detect various inputs including voluntary user inputs (e.g., input via a controller, voice command, body movement, or other convention control mechanism) and various biometric inputs (e.g., breathing patterns, heart rate, etc.). The media processing device 110 may execute the application 112 that provides an immersive VR experience to the user, which may include visual and audio media content. The application 112 may control presentation of media content in response to the various inputs detected by the media processing device 110. For example, the application 112 may adapt presentation of visual content as the user moves his or her head to provide an immersive VR experience. An embodiment of a media processing device 110 is described in further detail below with respect to FIG. 2.

The client devices 140 comprises a computing device that executes a client application 142 providing a user interface to enable the user to input and view information that is directly or indirectly related to media content provided by the media processing device 110. For example, the client application 142 may enable a user to set up a user profile that becomes paired with the application 112. Furthermore, the client application 142 may present various surveys to the user before and after experiences to gain information about the user's reaction to the experiences. In an embodiment, the client device 140 may comprise, for example, a mobile device, tablet, laptop computer, desktop computer, gaming console, or other network-enabled computer device.

The media server 130 comprises one or more computing devices for delivering media content to the media processing device(s) 110 via the network 120 and/or for interacting with the client device 140. For example, the media server 130 may stream media content to the media processing device(s) 110 to enable the media processing device(s) 110 to present the media content in real-time or near real-time. Alternatively, the media server 130 may enable the media processing device(s) 110 to download media content to be stored on the media processing device(s) 110 and played back locally at a later time. The media server 130 may furthermore obtain user data about users using the media processing device(s) 110 and process the data to dynamically generate media content tailored to a particular user. Particularly, the media server 130 may generate media content (e.g., in the form of a VR experience) that is predicted to improve a particular user's mood based on profile information associated with the user received from the client application 142 and a machine-learned model that predicts how users' moods improve in response to different VR experiences.

The network 120 may include any combination of local area and/or wide area networks, using both wired and/or wireless communication systems. In one embodiment, the network 120 uses standard communications technologies and/or protocols. In some embodiments, all or some of the communication links of the network 120 may be encrypted using any suitable technique.

Various components of the media system 100 of FIG. 1 such as the media server 130, the media device 110, and the client device 140 can each include one or more processors and a non-transitory computer-readable storage medium storing instructions therein that, when executed, cause the one or more processors to carry out the functions attributed to the respective devices described herein.

FIG. 2 is a block diagram of a media processing device 110, according to one or more embodiments. In the illustrated embodiment, the media processing device 110 comprises a processor 250, a storage medium 260, input/output devices 270, and sensors 280. Alternative embodiments may include additional or different components. In other embodiments, functionality of the components may be disparately distributed.

The input/output devices 270 include various input and output devices for receiving inputs to the media processing device 110 and/or providing outputs from the media processing device 110. In an embodiment, the input/output devices 270 may include a display 272, an audio output device 274, a user input device 276, and a communication device 278. The display 272 comprises an electronic device for presenting images or video content such as an LED display panel, an LCD display panel, or other type of display. The display 272 may comprise a head-mounted display that presents immersive VR content. The audio output device 274 may include one or more integrated speakers or a port for connecting one or more external speakers to play audio associated with the presented media content. The user input device 276 can comprise any device for receiving user inputs such as a touchscreen interface, a game controller, a keyboard, a mouse, a joystick, a voice command controller, a gesture recognition controller, or other input device. The communication device 278 comprises an interface for receiving and transmitting wired or wireless communications with external devices (e.g., via the network 120 or via a direct connection). For example, the communication device 278 may comprise one or more wired ports such as a USB port, an HDMI port, an Ethernet port, etc. or one or more wireless ports for communicating according to a wireless protocol such as Bluetooth, Wireless USB, Near Field Communication (NFC), etc.

The sensors 280 capture various sensor data that can be provided as additional inputs to the media processing device 110. For example, the sensors 280 may include a microphone 282, an inertial measurement unit (IMU) 284, and one or more biometric sensors 286. The microphone 282 captures ambient audio by converting sound into an electrical signal that can be stored or processed by the media processing device 110. The IMU 284 comprises an electronic device for sensing movement and orientation. For example, the IMU 284 may comprise a gyroscope for sensing orientation or angular velocity and an accelerometer for sensing acceleration. The IMU 284 may furthermore process data obtained by direct sensing to convert the measurements into other useful data, such as computing a velocity or position from acceleration data. In an embodiment, the IMU 284 may be integrated with the media processing device 110. Alternatively, the IMU 284 may be communicatively coupled to the media processing device 110 but physically separate from it so that the IMU 284 could be mounted in a desired position on the user's body (e.g., on the head or wrist).

The biometric sensors 286 comprise one or more sensors for detecting various biometric signals of a user. Example biometric signals include heart rate, breathing rate, blood pressure, temperature, electrocardiogram (EKG), electroencephalogram (EEG), or other biometric data. The biometric sensors may be integrated into the media processing device 110, or alternatively, may comprise separate sensor devices that may be worn at an appropriate location on the human body. In this embodiment, the biometric sensors may communicate sensed data to the media processing device 110 via a wired or wireless interface.

The storage medium 260 (e.g., a non-transitory computer-readable storage medium) stores a Application 112 comprising instructions executable by the processor 250 for carrying out functions attributed to the media processing device 110 described herein. In an embodiment, the Application 112 includes a content presentation module 262 and an input processing module 264. The content presentation module 262 presents media content via the display 272 and the audio output device 274. The input processing module 264 processes inputs received via the user input device 276 or from the sensors 280 and provides processed input data that may control the output of the content presentation module 262 or may be provided to the media processing server 130. For example, the input processing module 264 may filter or aggregate sensor data from the sensors 280 prior to providing the sensor data to the media server 130.

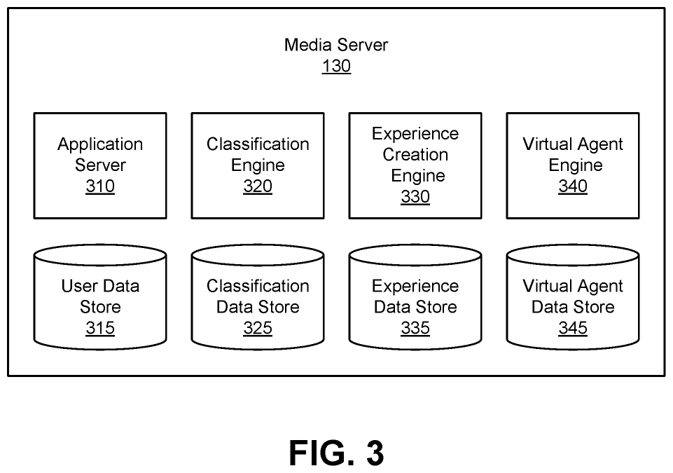

FIG. 3 is a block diagram of a media server 130, according to one or more embodiments. The media server 130 comprises an application server 310, a classification engine 320, an experience creation engine 330, a virtual agent engine 340, a user data store 315, a classification data store 325, an experience data store 335, and a virtual agent data store 345. In alternative embodiments, the media server 130 may comprise additional, fewer, or different components. For example, in a conversational platform context, the media server 130 may include just an application server 310 for hosting the conversational platform, a virtual agent engine 340, and virtual agent data store 345. Various components of the media server 130 may be implemented as a processor and a non-transitory computer-readable storage medium storing instructions that when executed by the processor causes the processor to carry out the functions described herein.

The application server 310 obtains various data associated with users of the application 112 and the client application 142 during and in between experiences and indexes the data to the user data store 315. For example, the application server 310 may obtain profile data from a user during an initial user registration process (e.g., performed via the client application 142) and store the user profile data to the user data store 315 in association with the user. The user profile information may include, for example, a date of birth, gender, age, and location of the user. Once registered, the user may pair the client application 142 with the application 112 so that usage associated with the user can be tracked and stored in the user data store 315 together with the user profile information.

In one embodiment, the tracked data includes survey data from the client application 112 obtained from the user between experiences, biometric data from the user captured during (or within a short time window before or after) the user participating in an experience, and usage data from the application 112 representing usage metrics associated with the user. For example, in one embodiment, the application server 310 obtains self-reported survey data from the client application 142 provided by the user before and after a particular experience. The self-reported survey data may include a first self-reported mood score (e.g., a numerical score on a predefined scale) reported by the user before the experience and a second self-reported mood score reported by the user after the experience. The application server 310 may calculate a delta between the second self-reported mood score and the first self-reported mood score, and store the delta to the user data store 315 as a mood improvement score associated with the user and the particular experience. Additionally, the application server 310 may obtain self-reported mood tracker data reported by the user via the client application 142 at periodic intervals in between experiences. For example, the mood tracker data may be provided in response to a prompt for the user to enter a mood score or in response to a prompt for the user to select one or more moods from a list of predefined defined moods representing how the user is presently feeling. The application server 310 may furthermore obtain other text-based feedback from a user and perform a semantic analysis of the text-based feedback to predict one or more moods associated with the feedback.

The application server 310 may furthermore obtain biometric data from the media processing device 110 that is sensed during a particular experience. Additionally, the application server 310 may obtain usage data from the media processing device 110 associated with the user's overall usage (e.g., characteristics of experiences experienced by the user, a frequency of usage, time of usage, number of experiences viewed, etc.).

All of the data associated with the user may be stored to the user data store 315 and may be indexed to a particular user and to a particular experience.

In some embodiments, the application server 310 tracks user responses to personalized content presented during an experience (e.g., a virtual reality meditative experience). The application server 310 may receive set(s) of signal(s) indicating a state of the user during the experience. The signal(s) may include biometric data, e.g., captured by the biometric sensors 286. The signal(s) may also include user-provided input in response to prompts provided by the application. Based on the received signal(s), the application server 310 may determine and track the user's mood over the course of the experience. The application server 310 may further track results of modifying the virtual agent and/or the experience in shifting the user's mood. For example, if the application server 310 is targeting the user's mood to be relaxed, the application server 310 can determine, at varying intervals, whether the user's mood is relaxed or otherwise. If otherwise, the application server 310 may modify the virtual agent and/or the experience to induce a shift of the user's mood towards the relaxed mood.

The user data store 315 stores data related to the users and used by the media server 130. In some embodiments, the user data store 315 may be structured as a knowledge graph. As a knowledge graph, which relates various data points relating to the users in a graph form. The knowledge graph may comprise nodes, edges, and labels. Nodes may represent data points, e.g., users, digital content, characteristics of the content (e.g., acoustic characteristics of the virtual agent), user states (e.g., mental, emotive, etc.), other data analyzed by the media server 130. The edges connect nodes, with the labels annotating or providing additional detail around the edge connections. In other embodiments, the user data store 315 is structured as a relational database which stores the data in series of tables, each structured with rows and columns.

Based on the efficacy of certain modifications, the application server 310 may build a preference model to generalize the user's responses to the modifications. If the modifications successfully shift the user's mood to the target mood, the application server 310 may record a positive result. If the modifications are unsuccessful, the application server 310 may record a negative result. In some embodiments, the application server 310 may further subdivide the preference model based on different circumstantial factors. Different circumstantial factors may include: season, time of day, weather (e.g., temperature, humidity, cloud cover, precipitation, wind speed, etc.), geographic location, etc. With the preference model, the application server 310 may personalize the virtual reality meditative experience to bias towards characteristics that induced positive results while biasing away from characteristics that induced negative results.

The classification engine 320 classifies data stored in the user data store 315 to generate aggregate data for a population of users. For example, the classification engine 320 may cluster users into user cohorts comprising groups of users having sufficiently similar user data in the user data store 315. When a user first registers with the media experience server 130, the classification engine 320 may initially classify the user into a particular cohort based on the user's provided profile information (e.g., age, gender, location, etc.). As the user participates in VR experiences, the user's survey data, biometric data, and usage data may furthermore be used to group users into cohorts. For example, based on the user's mood, the user's responses to personalized content, the user's response to particular psychedelic compounds, or some combination thereof, the classification engine 320 may reclassify users into different cohorts. Thus, the users in a particular cohort may change over time as the data associated with different users is updated. Likewise, the cohort associated with a particular user may shift over time as the user's data is updated. Based on the cohorts, the classification engine 320 may create baseline preference models, e.g., for a new user.

The classification engine 320 may furthermore aggregate data associated with a particular cohort to determine general trends in survey data, biometric data, and/or usage data for users within a particular cohort. Furthermore, the classification engine 320 may furthermore aggregate data indicating which digital assets were included in experiences experienced by users in a cohort. The classification engine 320 may index the aggregate data to the classification database 325. For example, the classification database 325 may index the aggregate data by gender, age, location, experience sequence, and assets. The aggregate data in the classification database 325 may indicate, for example, how mood scores changed before and after experiences including a particular digital asset. Furthermore, the aggregate data in the classification database 325 may indicate, for example, how certain patterns in biometric data correspond to surveyed results indicative of mood improvement.

The classification engine 320 may learn correlations between particular digital assets included in experiences viewed by users within a cohort and data indicative of mood improvement. The classification engine 320 may update the scores associated with the digital assets for a particular cohort based on the learned correlations.

The experience creation engine 330 generates the experience (e.g., a VR experience) by selecting digital assets from the experience asset database 335 and presenting the digital assets according to a particular time sequence, placement, and presentation attributes. For example, the experience creation engine 330 may choose a background scene or template that may be colored according to a particular color palette. Over time during the experience, the experience creation engine 330 may cause one or more graphical objects to appear in the scene in accordance with selected attributes that control when the graphical objects appear, where the graphical objects are placed, the size of the graphical object, the shape of the graphical object, the color of the graphical object, how the graphical object moves throughout the scene, when the graphical object is removed from the scene, etc. Similarly, the experience creation engine 330 may select one or more audio objects to start or stop at various times during the experience. For example, a background music or soundscape may be selected and may be overlaid with various sounds effects or spoken word clips. In some embodiments, the timing of audio objects may be selected to correspond with presentation of certain visual objects. For example, metadata associated with a particular graphical object may link the object to a particular sound effect that the experience creation engine 330 plays in coordination with presenting the visual object. The experience creation engine 330 may furthermore control background graphical and/or audio objects to change during the course of the experience, or may cause a color palette to shift at different times in the experience.

The experience creation engine 330 may intelligently select the which assets to present during an experience, the timing of the presentation, and attributes associated with the presentation to tailor the experience to a particular user. For example, the experience creation engine 330 may identify a cohort associated with the particular user, and select specific digital assets for inclusion in the experience based on their scores for the cohort and/or other factors such as whether the asset is a generic asset or a user-defined asset. In an embodiment, the process for selecting the digital assets may include a randomization component. For example, the experience creation engine 330 may randomly select from digital assets that have at least a threshold score for the particular user's cohort. Alternatively, the experience creation engine 330 may perform a weighted random selection of digital assets where the likelihood of selecting a particular asset is weighted based on the score for the asset associated with the particular user's cohort, weighted based on whether or not the asset is user-defined (e.g., with a higher weight assigned to user-defined assets), weighted based on how recently the digital asset was presented (e.g., with higher weight to assets that have not recently been presented), or other factors. The timing and attributes associated with presentation of objects may be defined by metadata associated with the object, may be determined based on learned scores associated with different presentation attributes, may be randomized, or may be determined based on a combination of factors. By selecting digital assets based on their respective scores, the experience creation engine 330 may generate an experience predicted to a have a high likelihood to improve the user's moods.

In an embodiment, the experience creation engine 330 pre-renders the experience before being playback such that the digital objects for inclusion and their manner of presentation are pre-selected. Alternatively, the experience creation engine 330 may render the experience in substantially real-time by selecting objects during the experience for presentation at a future time point within the experience. In this embodiment, the experience creation engine 330 may adapt the experience in real-time based on biometric data obtained from the user in order to adapt the experience to the user's perceived change in mood. For example, the experience creation engine 330 may compute a mood score based on acquired biometric information during the experience and may select digital assets for inclusion in the experience based in part on the detected mood score.

The experience data store 335 stores a plurality of digital assets that may be combined to create an experience. Digital assets may include, for example, graphical objects, audio objects, and color palettes. Each digital asset may furthermore be associated with asset metadata describing characteristics of the digital asset and stored in association with the digital asset. For example, a graphic object may have attribute metadata specifying a shape of the object, a size of the object, one or more colors associated with the object, etc.

Graphical objects may comprise, for example, a background scene or template (which may include still images and/or videos), and foreground objects (that may be still images, animated images, or videos). Foreground objects may move in three-dimensional space throughout the scene and may change in size, shape, color, or other attributes over time. Graphical objects may depict real objects or individuals, or may depict abstract creations.

Audio objects may comprise music, sound effects, spoken words, or other audio. Audio objects may include long audio clips (e.g., several minutes to hours) or very short audio segments (e.g., a few seconds or less). Audio objects may furthermore include multiple audio channels that create stereo effects.

Color palettes comprise a coordinated set of colors for coloring one or more graphical objects. A color palette may map a general color attributed to a graphical asset to specific RGB (or other color space) color values. By separating color palettes from color attributes associated with graphical objects, colors can be changed in a coordinated way during an experience independently of the depicted objects. For example, a graphical object (or particular pixels thereof) may be associated with the color “green”, gut the specific shade of green is controlled by the color palette, such that the object may appear differently as the color palette changes.

Digital assets may furthermore have one or more scores associated with them representative of a predicted association of the digital asset with an improvement in mood that will be experienced by a user having a particular user profile when the digital asset is included in an experience. In an embodiment, a digital asset may have a set of scores that are each associated with a different group of users (e.g., a “cohort”) that have similar profiles. Furthermore, the experience asset database 335 may track which digital assets were included in different experiences and to which users (or their respective cohorts) the digital assets were presented.

The experience creation engine 330 may generate the experience based on a type of media experience being provided. For example, in a gaming context, the experience is a virtual game. Within the game, there may be one or more virtual environments, one or more virtual characters (inclusive of voiceover tracks), one or more game objectives, game audio, other game elements, or some combination thereof. As another example, the experience may be a virtual reality experience (e.g., for meditation). In such context, there may be one or more virtual environment, a virtual agent (e.g., as a meditation guide), one or more virtual objects, other virtual elements, meditation audio, or some combination thereof. In a third example, the experience may be a conversational platform. In such context, there may be a virtual agent (inclusive of a voiceover track), a virtual background, other virtual elements, or some combination thereof presented in an interface. The interface could be a phone call, a video call, etc.

In an embodiment, the experience data store 335 may include user-defined digital assets that are provided by the user or obtained from profile data associated with the user. For example, the user-defined digital assets may include pictures of family members or pets, favorite places, favorite music, etc. The user-defined digital assets may be tagged in the experience data store 335 as being user-defined and available only to the specific user that the asset is associated with. Other digital assets may be general digital assets that are available to a population of users and are not associated with any specific user.

The virtual agent engine 340 may further personalize the experience with a virtual agent. The virtual agent is a virtual character that may interact with the user during the experience. In a gaming context, the virtual agent may be an interactive character. In a meditative context, the virtual agent may be a guide. In a conversational platform context, the virtual agent may converse with the user via an interface. The virtual agent may include a visual appearance, a voiceover track, or some combination thereof. The visual appearance of the virtual agent may be defined by a silhouette, a color, a size, a position, a brightness, any other visual characteristic, etc. The voiceover track may be defined by a voice, speech presented, loudness, pitch, tonal personality, any other acoustic characteristic, etc. Tonal personality may indicate a manner of speaking, e.g., cheeky, sassy, endearing, calm, assertive, angry, sad, etc. The virtual agent engine 340 may modify one or more characteristics of the virtual agent to personalize the virtual agent for the user.

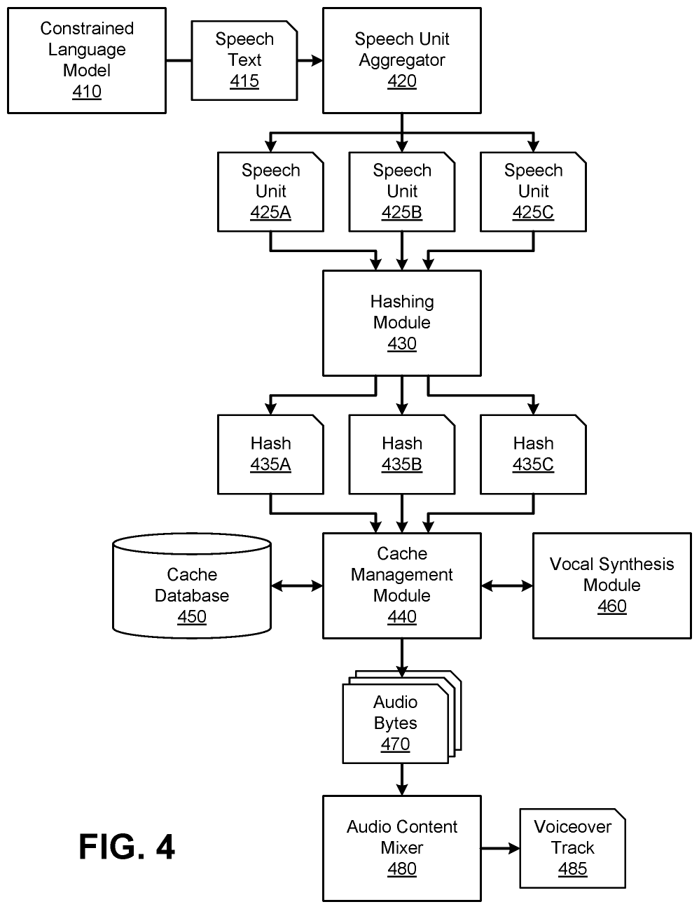

In some embodiments, the virtual agent engine 340 may generate adaptive speech with novel voiceover tracks for the virtual agent, e.g., with a large language model, thereby enabling human-like conversations between the user and the virtual agent. In generating the adaptive speech, the virtual agent engine 340 may leverage a machine-learned language model to generate the text for the adaptive speech, a vocal synthesis module to generate audio bytes for the text, and a cache database to store and cache generated audio bytes. Further description of the voiceover caching is described in FIGS. 4 & 5.

In further embodiments, the virtual agent engine 340 utilizes a user preference model to modify the virtual agent and/or the meditative experience to induce a mood shift in the user. The virtual agent engine 340 may use the user preference model to inform what characteristics to modify and how to modify such characteristics. For example, the user preference model may comprise a color palette preference of the user, e.g., learned through prior responses by the user to personalization modifications of the virtual reality meditative experience. Accordingly, the virtual agent engine 340 can modify the visual appearance of the virtual agent to accommodate the color palette preference of the user. In some embodiments, the virtual agent engine 340 may apply a baseline user preference model for the initially-assigned cohort of a new user. In such embodiments, the application server 310 has yet to generate a user preference model for the new user. As such, the virtual agent engine 340 may utilize a baseline user preference model (e.g., as an aggregate of other user preference models of users in the cohort) to personalize the experience for the new user. Based on the user's responses to the personalization modifications, the application server 310 may tailor the user preference model accordingly.

The virtual agent data store 345 may further include content for generating the virtual agent of the virtual reality experience. The content may include renderings of the virtual agent, e.g., for different users. For example, the virtual reality application may create personalized virtual agents (e.g., akin to an avatar) for users. Each personalized virtual agent may be further stored in the experience data store 335. The content may also include voiceover tracks for the virtual agent. The voiceover tracks may be voice recordings, synthetically-generated voiceover tracks, or some combination thereof. The voice recordings may include recordings in different voices, e.g., by different voice actors. The virtual agent data store 345 may further include the cache database leveraged in voiceover caching. The cache database stores audio bytes in conjunction with cached hashes corresponding to speech units.

### Voiceover Caching of Adaptive Speech

FIG. 4 is an illustrative flowchart of virtual agent voiceover caching of adaptive speech, in accordance with one or more embodiments. The process may generate an adaptive voiceover track for a virtual agent, e.g., as an interactive character in a gaming experience, as a guide for a meditative experience, or as a conversationalist in a conversational platform. As a user interacts with the virtual reality experience, the adaptive speech can adapt to the user's interactions. Moreover, the voiceover track for the adaptive speech can leverage caching of audio bytes for speech units, to efficiently craft the voiceover track.

In one or more embodiments, the virtual agent engine 340 may perform the virtual agent voiceover caching of adaptive speech. In such embodiments, the virtual agent engine 340 may comprise a constrained language model 410, a speech unit aggregator 420, a hashing module 430, a cache management module 440, a vocal synthesis module 460, and an audio content mixer 480. A cache database 450 may be a component of the virtual agent database 340. In other embodiments, the constrained language model 410 may be a component of a third-party system in communication with the media server 130. In such embodiments, the media server 130 may engage with the constrained language model 410 by providing prompts to the third-party system to transform the prompts into responses, and by receiving the responses from the third-party system.

The constrained language model 410 generates speech text 415 based on prompts by the virtual agent engine 340. The prompts may include conversations by the user, e.g., of the media experience. For example, the user may speak, which is captured by a microphone (e.g., the microphone 282 of the media processing device 110). The user's speech may be transcribed into text with a speech recognition algorithm (e.g., which may be a machine-learned model). The prompt may further include information on circumstantial factors (e.g., season, time of day, user's state, geographical position, other environmental factors, etc.). Example details expanding on the machine-learned language model is described below. The generated speech text 415 may be in the form of streamed text or a block of text. The constrained language model 410 may also output information relating to tonality of the speech text 415 or other context. For example, the prompt to the constrained language model 410 may include a request to infer a tonality with which to deliver the speech text 415. Consequently, the response by the constrained language model 410 may select a tone from available tones (e.g., cheeky, sassy, endearing, calm, assertive, angry, sad, etc.). In other embodiments, the virtual agent engine 340 may leverage the user preference model to determine tonality separate from the speech text 415.

The speech unit aggregator 420 parses the speech text 415 into speech units 425. The speech units are portions of the speech text 415 that form cohesive portions of human speech. For example, humans generally do not speak or think one word at time, e.g., it would be odd for a human to say “Hello,” “my,” “name,” “is,” “Matt,” “what,” “is,” “your,” “name?” A more natural form of speaking would parse out the above example into phrases, sentences clauses, sentences, or some combination thereof (i.e., speech units). It would, consequently, be more natural for a human to say “Hello,” “my name is Matt,” “what is your name?” The speech unit aggregator 420 may be a machine-learned model that parses the speech text 415 into these speech units 425. The machine-learned model may be trained in a supervised manner, e.g., with annotations to the breaks between speech units. Such annotations may be provided by a human, or may be inferred from a speech recognition algorithm. In the illustration shown, the speech units 425 may include, for example, speech unit 425A, speech unit 425B, and speech unit 425C. Each speech unit may also include tonality information or other contextual tags (e.g., tags relating to other environmental factors).

The hashing module 430 transforms each speech unit into a corresponding hash. For example, the hashing module 430 transforms speech unit 425A into hash 435A, speech unit 425B into hash 435B, and speech unit 425C into hash 435C. The hashing module 430 may implement a fast non-cryptographic hashing function with good dispersion and randomness (e.g., xxHash). Each hash is distinct, such that a speech unit of “It's sunny today” and another speech unit of “It is a sunny day today” would yield different hashes. The hashing function operates as a transform of the speech unit space into a hashing space that may be of lower dimensionality than the speech unit space. In some embodiments, the hashes 435 may include tonality information for the speech units 425. As such, two speech units that have the same text but differing tonalities would yield different hashes. In other embodiments, the hashes 435 are based solely on the text of the speech unit and tonality information is tagged onto the hashes 435.

The cache management module 440 manages the hashes 435 to generate and/or to retrieve audio bytes 470 for the hashes 435. For each hash, the cache management module 440 queries the cache database 450 to determine if there's a matching cached hash with associated audio byte in the cache database 450. If the query yields a positive result, i.e., a matching hash exists in the cache database 450, the cache management module 440 retrieves the stored audio byte. If the query yields a negative result, i.e., there's no matching hash currently in the cache database 450, the cache management module 440 provides the speech unit associated with the non-cached hash to the vocal synthesis module 460. The vocal synthesis module 460 generates the audio byte for the speech unit, and provides the audio byte back to the cache management module 440. The vocal synthesis module 460 may leverage a machine-learned model that converts speech into audio bytes. The newly generated audio byte may be then stored with the hash in the cache database 450. In embodiments with tag(s) to the hashes 435, the cache management module 440 may query the cache database with the tagged hashes 435. A positive result would indicate there's a matching hash and corresponding tag. A negative result would indicate either (1) that there's no matching hash, or (2) there's a matching hash with no matching tag.

The audio content mixer 480 combines the audio bytes 470 to generate the voiceover track 485. The audio content mixer 480 may assemble the audio bytes 470 in order based on the speech text 415. For example, the order may include the audio byte for the speech unit 425A, the audio byte for the speech unit 425B, and the audio byte for the speech unit 425C. The voiceover track 485 is provided, e.g., to the media processing device 110 for presentation to the user during a virtual reality meditative experience.

### Example Methods

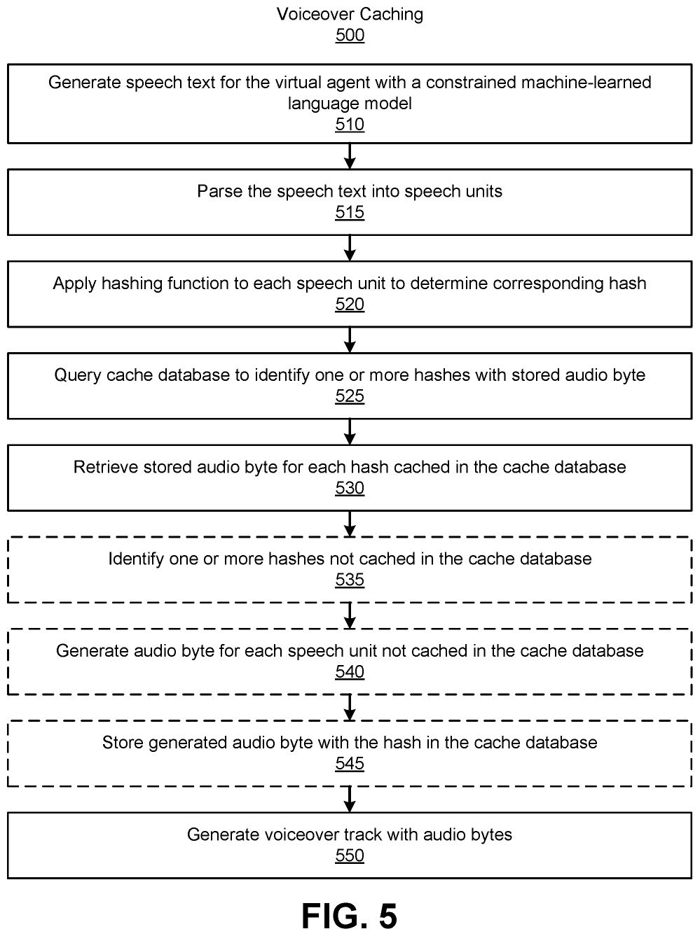

FIG. 5 is a method flowchart of virtual agent voiceover caching of adaptive speech, according to one or more embodiments. A system is described as performing the method flowchart. In other embodiments, specific computing devices may perform the method flowchart, e.g., the media processing device 110, the media server 130, or more generally the media system 100.

The system may initialize a virtual reality meditative experience including a virtual agent. The system may present the virtual reality meditative experience via a virtual reality headset, e.g., the media processing device 110, or any other headset device including at least a display device and/or an audio device. The virtual agent is a virtual character in the experience that may interact with the user. For example, the virtual agent may provide guidance (e.g., in the form of movement and/or speech) to navigate a user through a virtual reality meditative experience. The virtual agent may respond to inputs by the user.

The system generates 510 speech text for the virtual agent with a constrained machine-learned language model. The system may generate the speech text for the virtual agent by inputting a prompt to the constrained machine-learned language model, which would output a response to the prompt including the speech text. In some embodiments, the system may input prior conversations between the user and the virtual agent to inform the speech text. The constrained machine-learned language model may also output a tonality of the speech text. The system parses 515 the speech text into a plurality of speech units. Parsing the speech text may entail grouping one or more words into each speech unit. The speech unit is an atomic unit of human speech and may be representative of natural breaks within human speech, e.g., phrases, sentence clauses, or sentences.

The system applies 520 a hashing function to each speech unit to determine a corresponding hash. The system may further input the tonality in conjunction with the speech unit. The hashing function transforms the language space into a hashing space, e.g., without reduced dimensionality. Hashes may be distinct.

The system, for each hash, queries 525 a cache database to identify one or more hashes with stored audio bytes. The cache database may store hashes with generated audio bytes. In querying the cache database, the system determines whether a cached hash matches to a queried hash.

The system retrieves 530 a stored audio byte for each hash that is cached in the cache database. Responsive to identifying that there's a matching hash in the cache database, the system may retrieve the stored audio byte.

The system identifies 535 one or more hashes not cached in the cache database. If there is no matching hash, then there is no previously generated audio byte for that speech unit.

The system generates 540 an audio byte for each speech unit that did not have a cached has in the cache database. The system may use a vocal synthesizer to generate the audio byte. The vocal synthesizer may further input tonality in generating the audio byte.

The system stores 545 the generated audio byte with the hash in the cache database. This iteratively builds up the cache database with more and more stored audio bytes that continuously improves the voiceover caching workflow.

The system generates 550 the voiceover track with the audio bytes. The voiceover track may string together audio bytes retrieves from the cache database and/or audio bytes generated by the vocal synthesizer. The voiceover track may be presented in the virtual reality experience, e.g., by a media processing device.

### Example Virtual Reality Meditative Experience

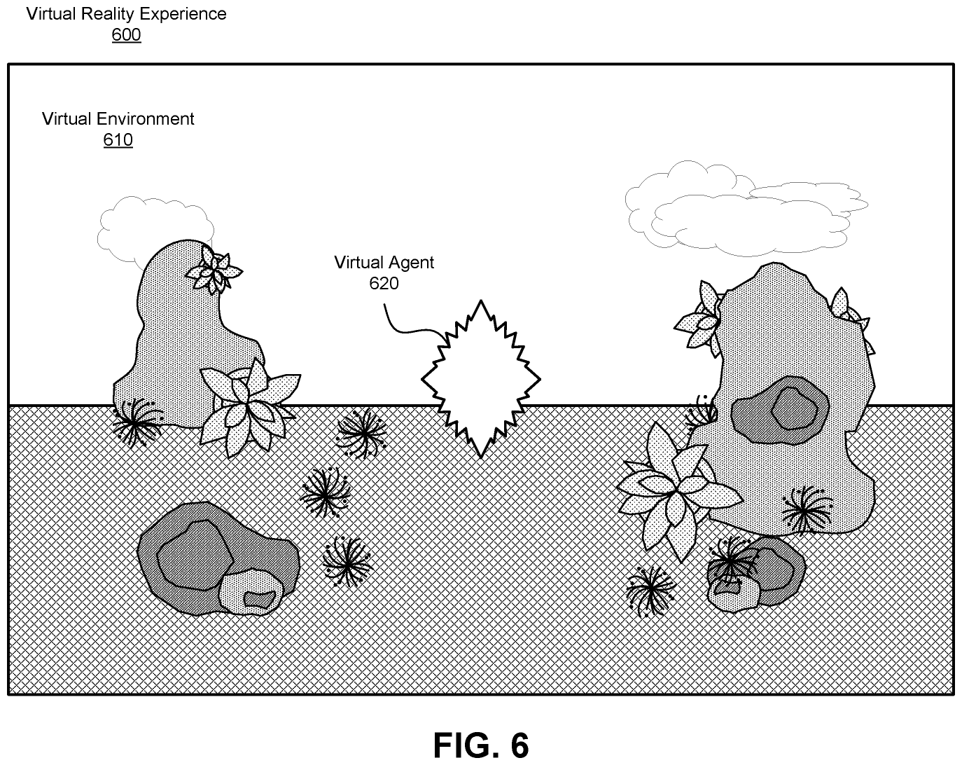

FIG. 6 illustrates an example virtual reality experience 600 including a virtual agent 620, according to one or more example implementations. The VR experience 600 includes visual content presented to the user, e.g., via a display device on a VR headset. The visual content may include presenting a virtual environment 610 with one or more virtual elements (e.g., digital assets). The virtual agent 620 may have a visual appearance and may include a voiceover track. The virtual agent 620 interacts with the user, providing guidance through the VR experience 600.

During the VR Experience 600, the System May Modify Characteristics of the Virtual agent 620 to induce a shift of the user's mood. For example, the system may change a silhouette of the virtual agent 620, a size of the virtual agent 620, a color of the virtual agent 620, a position of the virtual agent 620, a translucence of the virtual agent 620, a brightness of the virtual agent 620, etc. The system may also change acoustic characteristics of the virtual agent 620, by changing the voiceover track, the loudness, the pitch, the voice, etc. In some embodiments, the system may leverage the voiceover caching of adaptive speech to provide a generative voiceover track at low latency.

### Example Machine-Learned Language Model

A machine-learned language model performs inference tasks. The inference tasks include, but are not limited to, natural language processing (NLP) tasks, audio processing tasks, image processing tasks, video processing tasks, and the like. The NLP tasks include, but are not limited to, text generation, query processing, machine translation, chatbot applications, and the like. In one or more embodiments, the language model is configured as a transformer neural network architecture. Specifically, the transformer model is coupled to receive sequential data tokenized into a sequence of input tokens and generates a sequence of output tokens depending on the inference task to be performed.

In some embodiments, the model operates with tokenized inputs and outputs. For example, a text prompt (e.g., an input) may be tokenized into its individual units, with the individual tokens input into machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a prompt and generate a sequence of output tokens that represent a response to the prompt. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text. In some embodiments, the response from the machine-learned language model may be a stream of text units composing the response or may be a block of text composing the whole response.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many inference tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units (GPUs) for training or deploying deep neural network models. In one instance, the LLM may be trained and hosted on a cloud infrastructure service. The LLM may be trained by the media server 130. An LLM may be trained on a large amount of data from various data sources. For example, the data sources include websites, articles, posts on the web, and the like. From this massive amount of data coupled with the computing power of LLMs, the LLM is able to perform various inference tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like. The LLM is configured to receive a prompt and generate a response to the prompt. The prompt may include a task request and additional contextual information that is useful for responding to the query. The LLM infers the response to the query from the knowledge that the LLM was trained on and/or from the contextual information included in the prompt.

In one or more embodiments, the machine-learned language model may be constrained to output responses within a constrained language space. The constrained language space may include language related to a particular set of topic(s). For example, in implementations with the virtual reality meditative experience, the constrained space may include content related to the virtual reality meditative experience, which may include: information on the user's state (e.g., mood, emotional, physical, spiritual, or some combination thereof), information on the user's meditative experience, information on the user, information on the virtual reality experience, information on circumstantial factors, tonality of the virtual agent, etc.

### ADDITIONAL CONSIDERATIONS

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements that are not in direct contact with each other, but yet still co-operate or interact with each other.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate still additional alternative structural and functional designs for the described embodiments as disclosed from the principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the scope defined in the appended claims.

What is claimed is:

1. A computer-implemented method comprising:
initializing a virtual experience for a user, the virtual experience including a virtual agent;
receiving speech text from a constrained machine-learned language model configured to provide adaptive speech relating to the virtual experience;
parsing the speech text into a plurality of speech units, wherein a speech unit is an atomic unit representative of natural breaks in human speech;
apply a hashing function to each speech unit to determine a corresponding hash;
for each hash, querying a cache database to identify a cached hash that matches the hash queried against the cache database;
responsive to identifying a matching hash to a first hash queried against the cache database, retrieving a first audio byte stored with the matching hash in the cache database; and
generating a voiceover track for the virtual agent with the first audio byte.

2. The computer-implemented method of claim 1, further comprising:
generating a prompt for the constrained machine-learned language model specifying speech of the user and a request to infer a reply to the speech of the user; and
providing the prompt to the constrained machine-learned language model.

3. The computer-implemented method of claim 2, wherein generating prompt comprises:
generating the prompt further specifying prior conversations between the user and the virtual agent in a prior session of the virtual experience.

4. The computer-implemented method of claim 2, further comprising:
receiving an audio signal captured by a microphone, the audio signal representing the speech of the user; and
applying a speech recognition algorithm to the audio signal to determine the speech of the user.

5. The computer-implemented method of claim 1, wherein the constrained machine-learned language model is trained to output adaptive speech in a constrained language space relevant to the virtual experience.

6. The computer-implemented method of claim 1, further comprising:
determining a tonality for the speech text from the constrained machine-learned language model.

7. The computer-implemented method of claim 6, wherein applying the hashing function comprises:
applying the hashing function to each speech unit and the tonality to determine the corresponding hash.

8. The computer-implemented method of claim 6, further comprising:
tagging the hashes corresponding to the plurality of speech units with a tag indicating the tonality.

9. The computer-implemented method of claim 1, wherein parsing the speech text into the plurality of speech units comprises grouping one or more words from the speech text into a speech unit.

10. The computer-implemented method of claim 9, wherein the plurality of speech units are phrases, sentence clauses, or sentences.

11. The computer-implemented method of claim 1, further comprising:
responsive to identifying no matching hash in the cache database to a second hash queried against the cache database, generating a second audio byte for the speech unit corresponding to the second hash with a voice synthesizer,
wherein generating the voiceover track for the virtual agent comprises combining the first audio byte and the second audio byte.

12. The computer-implemented method of claim 11, further comprising:
storing the second audio byte with the second hash in the cache database.

13. The computer-implemented method of claim 1, further comprising:
transmitting the voiceover track for the virtual agent for presentation in the virtual experience to the user.

14. A non-transitory computer-readable storage medium storing instructions that, when executed by a computer processor, cause the computer processor to perform operations comprising:
initializing a virtual experience for a user, the virtual experience including a virtual agent;
receiving speech text from a constrained machine-learned language model configured to provide adaptive speech relating to the virtual experience;
parsing the speech text into a plurality of speech units, wherein a speech unit is an atomic unit representative of natural breaks in human speech;
apply a hashing function to each speech unit to determine a corresponding hash;
for each hash, querying a cache database to identify a cached hash that matches the hash queried against the cache database;
responsive to identifying a matching hash to a first hash queried against the cache database, retrieving a first audio byte stored with the matching hash in the cache database; and
generating a voiceover track for the virtual agent with the first audio byte.

15. The non-transitory computer-readable storage medium of claim 14, the operations further comprising:
generating a prompt for the constrained machine-learned language model specifying speech of the user and a request to infer a reply to the speech of the user; and
providing the prompt to the constrained machine-learned language model.

16. The non-transitory computer-readable storage medium of claim 15, the operations further comprising:
receiving an audio signal captured by a microphone, the audio signal representing the speech of the user; and
applying a speech recognition algorithm to the audio signal to determine the speech of the user.

17. The non-transitory computer-readable storage medium of claim 14, wherein the constrained machine-learned language model is trained to output adaptive speech in a constrained language space relevant to the virtual experience.

18. The non-transitory computer-readable storage medium of claim 14, the operations further comprising:
determining a tonality for the speech text from the constrained machine-learned language model,
wherein applying the hashing function comprises applying the hashing function to each speech unit and the tonality to determine the corresponding hash.

19. The non-transitory computer-readable storage medium of claim 14, wherein parsing the speech text into the plurality of speech units comprises grouping one or more words from the speech text into a speech unit, wherein the plurality of speech units are phrases, sentence clauses, or sentences.

20. The non-transitory computer-readable storage medium of claim 14, the operations further comprising:
responsive to identifying no matching hash in the cache database to a second hash queried against the cache database, generating a second audio byte for the speech unit corresponding to the second hash with a voice synthesizer; and
storing the second audio byte with the second hash in the cache database,
wherein generating the voiceover track for the virtual agent comprises combining the first audio byte and the second audio byte.
